(19) United States
(12) Patent Application Publication
(10) Pub. No.: US 2008/0139387 A1
(43) Pub. Date: Jun. 12, 2008

(54) Fungicidal Mixtures

(75) Inventors: Jordi Tormo i Blasco, Laudenbach (DE); Thomas Grote, Wachenheim (DE); Maria Scherer, Godramstein (DE); Reinhard Stierl, Freinsheim (DE); Siegfried Strathmann, Limburgerhof (DE); Ulrich Schofl, Bruhl (DE)

Correspondence Address: BIRCH STEWART KOLASCH & BIRCH, PO BOX 747, FALLS CHURCH, VA, 22040-0747, US

(73) Assignee: BASF Aktiengesellschaft, Ludwigshafen (DE)

(21) Appl. No.: 10/585,981

(22) PCT Filed: Jan. 15, 2005
(86) PCT No.: PCT/EP05/00379

§ 371 Date: Jul. 13, 2006

(30) Foreign Application Priority Data
Jan. 27, 2004 (DE) 10 2004 004 215.2

(51) Int. Cl. A01N 25/34; A01N 43/84; A01P 3/00

(52) U.S. Cl. 504/100; 514/231.2

(57) ABSTRACT

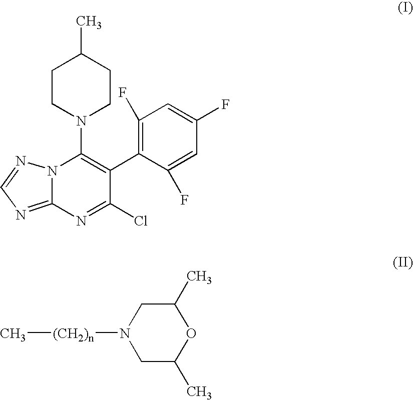

The invention relates to fungicidal mixtures for the control of fungal pests harmful to plants, comprising the active components 1) the triazolopyrimidine derivative of formula (1), and 2) tridemorph of formula (II), in which n=10, 11, 12 (60-70%) or 14, in a synergistically-effective amount, method for the control of fungal pests using mixtures of compound (I) with the compounds (II), the use of compound (I) with the compounds (II) for the production of such mixtures and means comprising said mixtures.

The present invention relates to fungicidal mixtures for controlling phytopathogenic harmful fungi, which mixtures comprise, as active components,

1) the triazolopyrimidine derivative of the formula I

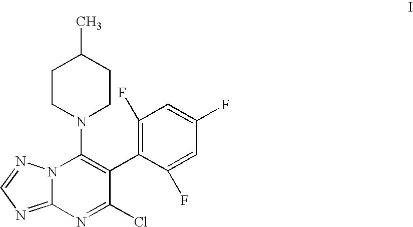

and

2) tridemorph of the formula II

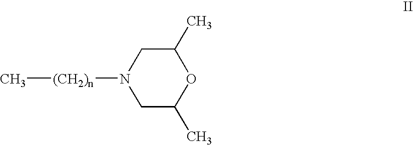

in which n is 10, 11, 12 (60-70%) or 14, in a synergistically effective amount.

Moreover, the invention relates to a method for controlling harmful fungi using mixtures of the compound I with the compounds II and to the use of the compound I with the compounds II for preparing such mixtures, and to compositions comprising these mixtures.

The compound 1,5-chloro-7-(4-methylpiperidin-1-yl)-6-(2,4,6-trifluorophenyl)-[1,2,4]tri-azolo[1,5-a]pyrimidine, its preparation and its action against harmful fungi are known from the literature (WO 98/46607).

The mixture of the N-alkylmorpholine derivatives II which, as main component, comprises 2,6-dimethyl-4-tridecylmorpholine, its preparation and its action against harmful fungi are likewise known from the literature (DE-AS 11 64 152; common name: tridemorph).

Mixtures of triazolopyrimidine derivatives with other active compounds are known generally from EP-A 988 790 and U.S. Pat. No. 6,268,371.

The synergistic mixtures disclosed in EP-A 988 790 are described as being fungicidally active against various diseases of cereals, fruit and vegetables, in particular mildew on wheat and barley or gray mold on apples. The mixtures disclosed in U.S. Pat. No. 6,268,371 are described as being particularly suitable for use against rice diseases.

It is an object of the present invention to provide, with a view to an effective control of harmful fungi, at application rates which are as low as possible, mixtures which, at a reduced total amount of active compounds applied, have an improved activity against harmful fungi (synergistic mixtures).

The mixtures defined at the outset have accordingly been found. Moreover, we have found that simultaneous, that is joint or separate, application of the compound I and the compound II or successive application of the compound I and the compound II allows better control of harmful fungi, in particular rice pathogens, than is possible with the individual compounds.

The mixtures of the compound I and the compounds II or the simultaneous, that is joint or separate, use of the compound I and the compounds Ii are distinguished by being highly active against a broad spectrum of phytopathogenic fungi, in particular from the classes of the Ascomycetes, Deuteromycetes, Oomycetes and Basidiomycetes. They can be used in crop protection as foliar and soil-acting fungicides.

They are particularly important in the control of a multitude of fungi on various cultivated plants, such as bananas, cotton, vegetable species (for example cucumbers, beans and cucurbits), barley, grass, oats, coffee, potatoes, corn, fruit species, rice, rye, soya, tomatoes, grapevines, wheat, ornamental plants, sugar cane and a large number of seeds.

The are advantageously suitable for controlling the following phytopathogenic fungi: Blumeria graminis (powdery mildew) on cereals, Erysiphe cichoracearum and Sphaerotheca fuliginea on cucurbits, Podosphaera leucotricha on apples, Uncinula necator on grapevines, Puccinia species on cereals, Rhizoctonia species on cotton, rice and lawns, Ustilago species on cereals and sugar cane, Venturia inaequalis on apples, Bipolaris and Drechslera species on cereals, rice and lawns, Septoria nodorum on wheat, Botrytis cinerea on strawberries, vegetables, ornamental plants and grapevines, Mycosphaerella species on bananas, peanuts and cereals, Pseudocercosporella herpotrichoides on wheat and barley, Pyricularia oryzae on rice, Phytophthora infestans on potatoes and tomatoes, Pseudoperonospora species on cucurbits and hops, Plasmopara viticola on grapevines, Alternaria species on fruit and vegetables and also Fusarium and Verticillium species.

The mixtures according to the invention are of particular importance for controlling harmful fungi on rice plants and the seeds thereof, such as Bipolaris and Drechslera species, and also Pyricularia oryzae. They are particularly suitable for controlling brown spot of rice caused by Cochliobolus miyabeanus.

Typical rice pathogens are different from those in cereals or fruit. Pyricularia oryzae and Corticium sasakii (syn. Rhizoctonia solani) are the causative organisms of the most important diseases in rice plants. Rhizoctonia solani is the only pathogen of agrocultural importance from the sub-class of the Agarcomycetidae. Unlike most other fungi, this fungus infects the plant not via spores but via a mycelium infection.

The mixtures according to the invention can also be used in the protection of materials (e.g. the protection of wood), for example against Paecilomyces variotii.

When preparing the mixtures, it is preferred to employ the pure active compounds I and II, to which further active compounds against harmful fungi or against other pests, such as insects, arachnids or nematodes, or also herbicidal or growth-regulating active compounds or fertilizers can be added according to need.

Other suitable active compounds in the above sense are in particular fungicides selected from the following groups:
acylalanines, such as benalaxyl, ofurace, oxadixyl,
amine derivatives, such as aldimorph, dodemorph, guazatine, iminoctadine,
anilinopyrimidines, such as pyrimethanil, mepanipyrim or cyprodinil,
antibiotics, such as cycloheximid, griseofulvin, kasugamycin, natamycin, polyoxin or streptomycin,
azoles, such as bitertanol, bromoconazole, cyproconazole, difenoconazole, dinitroconazole, enilconazole, epoxiconazole, fenbuconazole, fluquinconazole, flusilazole, flutriafol, hexaconazole, imazalil, ipconazole, metconazole, myclobutanil, penconazole, propiconazole, prochloraz, prothioconazole, simeconazole, tebuconazole, tetraconazole, triadimefon, triadimenol, triflumizol, triticonazole,
dicarboximides, such as myclozolin, vinclozolin,
dithiocarbamates, such as ferbam, nabam, metam, propineb, polycarbamate, ziram, zineb,
heterocyclic compounds, such as anilazine, boscalid, oxycarboxin, cyazofamid, dazomet, famoxadone, fenamidone, fuberidazole, flutolanil, furametpyr, isoprothiolane, mepronil, nuarimol, probenazole, pyroquilon, silthiofam, thiabendazole, thifluzamid, tricyclazole, triforine,
nitrophenyl derivatives, such as binapacryl, dinobuton, nitrophthal-isopropyl,
other fungicides, such as acibenzolar-S-methyl, carpropamid, cyflufenamid, cymoxanil, diclomezine, diclocymet, diethofencarb, edifenphos, ethaboxam, fentinacetate, fenoxanil, ferimzone, fosetyl, hexachlorobenzene, metrafenon, propamocarb, phthalide, toloclofos-methyl, quintozene, zoxamide,
strobilurins, such as fluoxastrobin, metominostrobin, orysastrobin or pyraclostrobin,
sulfenic acid derivatives, such as captafol,
cinnamides and analogous compounds, such as flumetover.

In one embodiment of the mixtures according to the invention, a further fungicide III or two fungicides III and IV are added to the compounds I and II. Preference is given to mixtures of the compounds I and II with a component III. Particular preference is given to mixtures of the compounds I and II.

The compound I and the compounds II can be applied simultaneously, that is jointly or separately, or in succession, the sequence, in the case of separate application, generally not having any effect on the result of the control measures.

The compound I and the compounds II are usually applied in a weight ratio of from 100:1 to 1:100, preferably from 20:1 to 1:50, in particular from 10:1 to 1:10.

The components III and, if appropriate IV are added if desired in a ration of from 20:1 to 1:20 with respect to the compound I.

Depending on the type of compound and of the desired effect, the application rates of the mixtures according to the invention are from 5 g/ha to 1000 g/ha, preferably from 50 to 850 g/ha, in particular from 50 to 750 g/ha.

Correspondingly, the application rates for the compound I are generally from 1 to 1000 g/ha, preferably from 10 to 750 g/ha, in particular from 20 to 500 g/ha.

Correspondingly, the application rates for the compounds II are generally from 1 to 1000 g/ha, preferably from 10 to 750 g/ha, in particular from 20 to 500 g/ha.

In the treatment of seed, application rates of mixture are generally from 1 to 1000 g/100 kg of seed, preferably from 1 to 200 g/100 kg, in particular from 5 to 100 g/100 kg.

In the control of phytopathogenic harmful fungi, the separate or joint application of the compounds I and II or of the mixtures of the compounds I and II is carried out by spraying or dusting the seeds, the seedlings, the plants or the soil before or after sowing of the plants or before or after emergence of the plants. The compounds are preferably applied by spraying the leaves. Joint or separate application of the compounds can also be carried out by applying granules or by dusting the soil.

The mixtures according to the invention, or the compounds I and II can be converted into the customary formulations, for example solutions, emulsions, suspensions, dusts, powders, pastes and granules. The use form depends on the particular intended purpose; in each case, it should ensure a fine and even distribution of the compound according to the invention.

The formulations are prepared in a known manner, for example by extending the active compound with solvents and/or carriers, if desired using emulsifiers and dispersants. Solvents/auxiliaries suitable for this purpose are essentially:
water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used,
carriers, such as ground natural minerals (for example kaolins, clays, talc, chalk) and ground synthetic minerals (for example highly disperse silica, silicates); emulsifiers, such as nonionic and anionic emulsifiers (for example polyoxyethylene fatty alcohol ethers, alkylsulfonates and arylsulfonates), and dispersants, such as lignosulfite waste liquors and methylcellulose.

Suitable surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol and nonylphenol, alkylphenyl polyglycol ethers, tributylphenyl polyglycol ethers, tristearylphenyl polyglycol ethers, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetals, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone or water.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths, such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compounds. The active compounds are employed in a purity of from 90% to 100%, preferably 95% to 100% (according to the NMR spectrum).

The following are examples of formulations:

1. Products for dilution with water

A) Water-Soluble Concentrates (SL)

10 parts by weight of the active compounds are dissolved in water or in a water-soluble solvent. As an alternative, wetters or other auxiliaries are added. The active compound dissolves upon dilution with water.

B) Dispersible Concentrates (DC)

20 parts by weight of the active compounds are dissolved in cyclohexanone with addition of a dispersant, for example polyvinylpyrrolidone. Dilution with water gives a dispersion.

C) Emulsifiable Concentrates (EC)

15 parts by weight of the active compounds are dissolved in xylene with addition of calcium dodecylbenzenesulfonate and castor oil ethoxylate (in each case 5% strength). Dilution with water gives an emulsion.

D) Emulsions (EW, EO)

40 parts by weight of the active compounds are dissolved in xylene with addition of calcium dodecylbenzenesulfonate and castor oil ethoxylate (in each case 5% strength). This mixture is introduced into water by means of an emulsifying machine (Ultraturrax) and made into a homogeneous emulsion. Dilution with water gives an emulsion.

E) Suspensions (SC, OD)

In an agitated ball mill, 20 parts by weight of the active compounds are comminuted with addition of dispersants, wetters and water or an organic solvent to give a fine active compound suspension. Dilution with water gives a stable suspension of the active compound.

F) Water-dispersible granules and water-soluble granules (WG, SG)

50 parts by weight of the active compounds are ground finely with addition of dispersants and wetters and prepared as water-dispersible or water-soluble granules by means of technical appliances (for example extrusion, spray tower, fluidized bed). Dilution with water gives a stable dispersion or solution of the active compound.

G) Water-dispersible powders and water-soluble powders (WP, SP)

75 parts by weight of the active compounds are ground in a rotor-stator mill with addition of dispersants, wetters and silica gel. Dilution with water gives a stable dispersion or solution of the active compound.

2. Products to be applied undiluted

H) Dustable powders (DP)

5 parts by weight of the active compounds are ground finely and mixed intimately with 95% of finely divided kaolin. This gives a dustable product.

I) Granules (GR, FG, GG, MG)

0.5 part by weight of the active compounds is ground finely and combined with 95.5% of carriers. Current methods are extrusion, spray-drying or the fluidized bed. This gives granules to be applied undiluted.

J) ULV solutions (UL)

10 parts by weight of the active compounds are dissolved in an organic solvent, for example xylene. This gives a product to be applied undiluted.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. However, it is also possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Oils of various types, wetters, adjuvants, herbicides, fungicides, other pesticides, or bactericides may be added to the active compounds, even, if appropriate, not until immediately prior to use (tank mix). These agents can be admixed with the compositions according to the invention typically in a weight ratio of from 1:10 to 10:1.

The compounds I and II or the mixtures or the corresponding formulations are applied by treating the harmful fungi or, the plants, seeds, soils, areas, materials or spaces to be kept free therefrom with a fungicidally effective amount of the mixture or, in the case of separate application, of the compounds I and II. Application can be carried out before or after infection by the harmful fungi.

The fungicidal action of the compound and of the mixtures may be revealed by the following tests:

The active compounds, separately or jointly, were prepared as a stock solution comprising 0.25% by weight of active compound in acetone or DMSO. 1% by weight of the emulsifier Uniperol® EL (wetting agent having emulsifying and dispersing action based on ethoxylated alkylphenols) was added to this solution, and the mixture was appropriately diluted with water to the desired concentration.

Use example—Activity against brown spot of rice caused by Cochliobolus miyabeanus, protective application

Leaves of rice seedlings of the cultivar “Tai-Nong 67” which had been grown in pots were sprayed to runoff point with an aqueous suspension having the concentration of active compound stated below. The next day, the plants were inoculated with an aqueous spore suspension of Cochliobolus miyabeanus. The test plants were then placed in climatized chambers at 22-24° C. and 95-99% relative atmospheric humidity for six days. The extent of the development of infection on the leaves was then determined visually.

Evaluation is carried out by determining the infected leaf areas in percent. These percentages were converted into efficacies.

The efficacy (E) is calculated as follows using Abbot's formula:

E=(1−α/β)·100

α corresponds to the fungal infection of the treated plants in % and

β corresponds to the fungal infection of the untreated (control) plants in %

An efficacy of 0 means that the infection level of the treated plants corresponds to that of the untreated control plants; an efficacy of 100 means that the treated plants are not infected.

The expected efficacies of the mixtures of active compounds are determined using Colby's formula [R. S. Colby, Weeds, 15, 20-22 (1967)] and are compared with the observed efficacies.

Colby's formula:

E=x+y−xy/100

### E expected efficacy, expressed in % of the untreated control, when using the mixture of the active compounds A and B at the concentrations a and b

x efficacy, expressed in % of the untreated control, when using active compound A at the concentration a

y efficacy, expressed in % of the untreated control, when using active compound B at the concentration b

TABLE A
Individual active compounds

| | | Concentration of | |
|---|---|---|---|
| | | active compound | Efficacy in % of |
| | | in the spray | the untreated |
| Example | Active compound | liquor [ppm] | control |
| 1 | control (untreated) | — | (88% infection) |
| 2 | I | 4 | 32 |
| 3 | II (tridemorph) | 16 | 9 |
| | | 4 | 0 |
| | | 1 | 0 |

TABLE B
Mixtures according to the invention

| | Mixture of active compounds | | |
|---|---|---|---|
| | Concentration; | Observed | Calculated |
| Example | Mixing ratio | efficacy | efficacy*) |
| 4 | I + II | 89 | 32 |
| | 4 + 1 ppm | | |
| | 4:1 | | |
| 5 | I + II | 97 | 32 |
| | 4 + 4 ppm | | |
| | 1:1 | | |
| 6 | I + II | 100 | 38 |
| | 4 + 16 ppm | | |
| | 1:4 | | |

*)calculated efficacy using Colby's formula

The test results show that at all mixing ratios the mixtures according to the invention are considerably more effective than had been predicted using Colby's formula.

1. A fungicidal mixture for controlling harmful fungi, which mixture comprises
1) the triazolopyrimidine derivative of the formula I 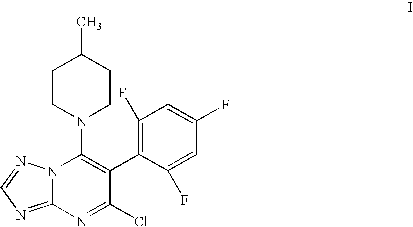
and
2) tridemorph of the formula II 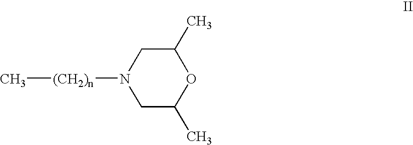
in which n is 10, 11, 12 (60-70%) or 14, in a synergistically effective amount.

2. The fungicidal mixture as claimed in claim 1, comprising the compound of the formula I and the compound of the formula II in a weight ratio of from 100:1 to 1:100.

3. A composition, comprising a liquid or solid carrier and a mixture as claimed in claim 1.

4. A method for controlling harmful fungi, which comprises treating the fungi, their habitat or the seed, the soil or the plants to be protected against fungal attack with an effective amount of the compound I and the compound II as set forth in claim 1.

5. The method according to claim 4, wherein the compounds I and II are applied simultaneously, that is jointly or separately, or in succession.

6. The method according to claim 4, wherein rice-pathogenic harmful fungi are controlled.

7. The method according to claim 4, wherein the compounds I and II or the mixture are applied in an amount of from 5 g/ha to 1000 g/ha.

8. The method according to claim 4, wherein the compounds I and II or the mixture are applied in an amount of from 1 to 1000 g/100 kg of seed.

9. Seed, comprising the mixture as claimed in claim 1 in an amount of from 1 to 1000 g/100 kg.

10. The use of the compounds I and II as set forth in claim 1 for preparing a composition suitable for controlling harmful fungi.

11. A composition, comprising a liquid or solid carrier and a mixture as claimed in claim 2.

12. The method wherein the compounds I and II as set forth in claim 1 are applied simultaneously, that is jointly or separately, or in succession.

13. The method according to claim 5, wherein rice-pathogenic harmful fungi are controlled.

14. The method according to claim 5, wherein the compounds I and II or the mixture are applied in an amount of from 5 g/ha to 1000 g/ha.

15. The method according to claim 6, wherein the compounds I and II or the mixture are applied in an amount of from 5 g/ha to 1000 g/ha.

16. The method wherein the compounds I and II as set forth in claim 1 or the mixture are applied in an amount of from 5 g/ha to 1000 g/ha.

17. The method wherein the compounds I and II or the mixture as claimed in claim 1 are applied in an amount of from 5 g/ha to 1000 g/ha.

18. The method wherein the compounds I and II or the mixture as claimed in claim 2 are applied in an amount of from 5 g/ha to 1000 g/ha.

19. The method according to claim 5, wherein the compounds I and II or the mixture are applied in an amount of from 1 to 1000 g/100 kg of seed.

20. The method according to claim 6, wherein the compounds I and II or the mixture are applied in an amount of from 1 to 1000 g/100 kg of seed.
